(19) United States
(12) Patent Application Publication
(10) Pub. No.: US 2005/0042345 A1
(43) Pub. Date: Feb. 24, 2005

(54) Process and apparatus for preparing meals

(76) Inventor: Paul Tasses, Merrylands (AU)

Correspondence Address: JAY S. CINAMON, ESQ.;ABELMAN, FRAYNE & SCHWAB, 150 East 42nd Street, New York, NY, 10017, US

(21) Appl. No.: 10/938,946

(22) Filed: Sep. 9, 2004

Related U.S. Application Data
(63) Continuation-in-part of application No. 09/980,307, filed on Nov. 28, 2001, now abandoned.

(30) Foreign Application Priority Data
Jan. 7, 2000 (AU) 10025/00

(51) Int. Cl. A23B 4/00

(52) U.S. Cl. 426/393

(57) ABSTRACT

A process for providing a home meal replacement as herein defined, comprising: (i) providing a carrier tray for each meal of the home meal replacement to be served, (ii) introducing the meal into each carrier tray and subjecting the meal to conditions that inhibit microorganism growth and contamination of the meal, the meal consisting of one or more foods that are introduced into each carrier tray at desired positions to simulate a gourmet meal, (iii) freezing the meal in each carrier tray to a temperature that enables the meal to be cold stored until the meal is ready to be served, (iv) providing a serving dish for each carrier tray wherein the serving dish is of a size and shape that corresponds substantially to that of the carrier tray, (v) manipulating each carrier tray in such a way that the frozen meal therein is transferred into its respective serving dish, the meal being presented in its respective serving dish such that the one or more foods are located in the same relative positions as in the respective carrier tray, and (iv) heating or thawing the meal in each serving dish to edible temperature for serving and consumption.

### CROSS REFERENCE TO RELATED APPLICATIONS

This application is a Continuation-in-Part of application Ser. No. 09/980,307, filed Nov. 28, 2001, which is a National Phase of PCT/AU01/00014, filed Jan. 8, 2001, which claims the priority benefit of Australian Application Ser. No. 10025/00, filed Jan. 7, 2000.

### FIELD OF INVENTION

The present invention relates to a process for providing meals of the kind required to meet the demand of home meal replacement, and to a carrier tray that carries the meal whilst frozen and that is adapted for easy and faithful transfer of the meal to a like sized and shaped serving dish where the look of the meal as prepared on the carrier tray is maintained.

More particularly, the present invention relates to a process for providing a home meal replacement defined as one or more meals having the look of a freshly prepared gourmet meal of restaurant quality when presented to the consumer but which are firstly prepared with the same look on carrier trays and then frozen at first locations, such as meal assembly plants, prior to delivery to second locations, such as the consumer's home, where the frozen meals are transferred from their carrier trays to like sized and shaped serving dishes whilst maintaining the same look of the meals and then are heated or thawed to edible temperature for consumption. The process has particular application to home delivery of gourmet style meals to couples or other small gatherings of people and the delivery of gourmet style meals to passengers on aircraft or to other large gatherings of people, all of whom desire to be provided with a gourmet meal having the look of a freshly prepared restaurant meal presented on formal crockery, although it is to be understood that the invention is not limited thereto in its application.

### BACKGROUND ART

Home delivery of hot cooked meals from fast food restaurants or the like has traditionally required foil or paper based/cardboard containers for carrying the meals to be delivered to the consumer. These meals, such as lasagne in foil containers or chicken and vegetables in cardboard containers, are usually delivered at edible temperature and are consumed either directly from their container or transferred onto appropriate crockery for consumption. In neither of these circumstances, however, does the meal as presented to the consumer have the look of a restaurant meal. Even where the meal is transferred onto a crockery dish, the meal will not readily maintain its look and will require special and time consuming attention during transfer and placement onto the crockery dish to ensure that it does not lose its shape, texture and other appearance characteristics as may be desired by the consumer to simulate a restaurant meal. In many cases, no amount of careful attention will enable the meal to look like a freshly prepared gourmet meal of restaurant quality.

Hitherto, precooked frozen meals may be purchased from supermarkets or the like and are heated to edible temperature in either their carrying containers or appropriate crockery onto which they have been transferred. Like home delivered hot cooked meals, precooked frozen meals presented to the consumer in this manner do not have the look of a freshly prepared gourmet meal of restaurant quality. The precooked frozen meal, heated to edible temperature on a crockery dish, will, by virtue of its packaging in a carrying container that is of unlike size and shape to that of the crockery dish, not assume the look of a freshly prepared gourmet meal of restaurant quality unless, of course, careful and time consuming attention is paid to its transfer and placement onto the crockery dish. Precooked frozen lasagne, for instance, is packaged snugly in a box-like container so as to abut against upright side walls of the container and must, if a person wishes to present it as a home meal replacement to guests, be very carefully removed therefrom for transfer onto a crockery dish of normally oval or circular shape but lacking similarly upright side walls, at all times seeking to avoid distorting the original upright shape or interfering with the texture of the lasagne. Once transferred onto such a crockery dish, the lasagne will nonetheless sag, distort, or otherwise lose its original shape and texture upon being heated to edible temperature given that it had required the upright side walls of the box-like container to maintain its upright shape and texture. Thus the look or overall appearance of the meal will be lost in the crockery dish.

Furthermore, it has hitherto been impossible to reliably visualize the look or appearance of a meal to be served to consumers on crockery from meals that are home delivered at edible temperature or precooked frozen meals. Nor has it been hitherto possible to present to the consumer a home delivered hot cooked meal or precooked frozen meal having the look of a freshly prepared gourmet meal of restaurant quality in a manner that is quick, easy and reliable. Still further, composite or multiple course meals may be provided by the present invention of, say, lasagne or soup as an entree course meal, filet mignon with vegetable accompaniment as a main course meal, and strawberry Romanoff as a dessert course meal, each of which course meal is provided in accordance with the process of the present invention and has the desired look as described hereinbefore.

In the application of the process of the present invention to large gatherings of people, the preparation of a bulk quantity of meals as a home meal replacement, being conventionally done by presenting the meals in universal serving dishes, is no longer a time consuming, high level handling operation that occasionally exposes the meals to risk of bacterial and other contamination prior to serving.

U.S. Pat. No. 4,574,174 to Thomas P McGonigle discloses a method, and an apparatus utilised in that method, for packaging of food in a storage container and transferring the food to a serving container capable of sustained cooking of the food. The method disclosed therein requires that the meal (to be cooked) be assembled in an upside down fashion in a lid (storage container) having at least one compartment (or more for separating each type of food) and then, when the meal is ready to be cooked, inverting the lid over a dish (serving container) which has a size that interfits with the lid and with any complementary compartments, so as to cause the meal to drop from the lid into the dish. The meal is then cooked in a microwave oven with the lid in place or is cooked on a conventional oven with the lid removed and foil covering the food.

However, the requirement that the meal stored in the lid be inverted over the dish, so as to cause the meal to drop from the lid into the dish, is not conducive to maintaining the shape of the meal from the lid to the dish especially for meals which are heterogeneous in shape between a top part and a bottom part, such as lasagne, soup, filet mignon with vegetable accompaniment, spaghetti Bolognese, and strawberry romanoff, and in fact may distort the shape of that meal in the inverting and dropping process. A purpose of the present invention is to prevent size and shape distortion from the time when the meal is introduced into the carrier tray to the time when it is served and consumed from the serving dish.

It is an object of the present invention to provide a process for providing a home meal replacement that is quick, easy, reliable and utilizes a carrier tray, in which a meal is prepared with the look of a gourmet meal of restaurant quality and then frozen to preserve that look, the carrier tray having a base portion and an upright surface portion against which a base portion and an upright surface portion of the meal abut and conform in size and shape thereto, and utilises a serving dish having a correspondingly sized and shaped base portion and upright surface portion to that of the carrier tray and onto which the frozen meal carried in the carrier tray is transferred so as to maintain the look of the meal as prepared in the carrier tray.

It is another object of the present invention to present a meal, which is heterogeneous in shape, in the carrier tray in an upright, ready to eat, orientation, (rather than in an upside down orientation as is disclosed in McGonigle) and to then introduce the meal in the serving dish in the same upright, ready to eat, orientation as it was presented in the carrier tray.

### SUMMARY OF THE INVENTION

According to the invention, there is provided a process for providing a meal of a home meal replacement, comprising:

(i) providing a carrier tray for the meal of the home meal replacement to be served, the carrier tray including a first base portion and a first upright surface portion having a size and a shape for receiving the meal thereagainst,

(ii) introducing the meal into the carrier tray so that a second base portion and a second upright surface portion of the meal abut against and conform in size and shape to the first base portion and to the first upright surface portion, the meal being heterogeneous in shape between at least a top part and a bottom part thereof, whereby the meal is presented in the carrier tray in an upright, ready to eat, orientation, and subjecting the meal to conditions that inhibit microorganism growth and contamination of the meal, the meal consisting of one or more foods that are introduced into the carrier tray at desired positions to simulate the look of a gourmet meal,

(iii) freezing the meal in the carrier tray to a temperature that enables the meal to be cold stored as a frozen meal until the meal is ready to be served, the size and the shape of the second base portion and the second upright surface portion of the meal thereby being preserved,

(iv) providing a serving dish for the carrier tray wherein the serving dish includes a third base portion and a third upright surface portion of a size and a shape that corresponds substantially to that of the first base portion and the first upright surface portion of the carrier tray,

(v) removing the frozen meal from the carrier tray and transferring it into the serving dish so that the second base portion and the second upright surface portion of the meal abut against and conform in size and shape to the third base portion and the third upright surface portion of the serving dish, the meal being presented in the serving dish in the upright, ready to eat, orientation, such that the look of a gourmet meal as prepared on the carrier tray is maintained, and

(iv) heating or thawing the meal in the serving dish to edible temperature for serving and consumption.

Preferably, the carrier tray is fabricated of a flexible plastic.

### BRIEF DESCRIPTION OF THE DRAWINGS

In order that the invention may be readily understood and put into practical effect, reference will now be made to the following drawings, in which:

FIG. 1 is a flow chart showing the steps of a preferred embodiment of the process of the invention,

FIG. 2 is a perspective view of a carrier tray for a soup utilised in a first step of a preferred process of the invention,

FIG. 3 is a perspective view of the carrier tray of FIG. 2 into which a soup has been introduced, sterilized and frozen in accordance with further steps of the process,

FIG. 4 is a perspective view of the frozen soup being removed from the carrier tray in accordance with a further step of the process,

FIG. 5 is a perspective view of the frozen soup being transferred into a serving dish for the soup in accordance with a further step of the process,

FIG. 6 is a perspective view of the serving dish of FIG. 5 into which the frozen soup has been introduced and heated in accordance with further steps of the process,

FIG. 7 in a perspective view of a carrier tray for spaghetti bolognese utilised in a first step of another preferred process of the invention,

FIG. 8 is a perspective view of the carrier tray of FIG. 7 into which spaghetti bolognese has been introduced, sterilised and frozen in accordance with further steps of the process,

FIG. 9 is a perspective view of the frozen spaghetti bolognese being removed from the carrier tray in accordance with a further step of the process,

FIG. 10 is a perspective view of the frozen spaghetti bolognese being transferred into a serving dish for the spaghetti bolognese in accordance with a further step of the process, and

FIG. 11 is a perspective view of the serving dish of FIG. 10 into which the frozen spaghetti bolognese has been introduced and heated in accordance with further steps of the process.

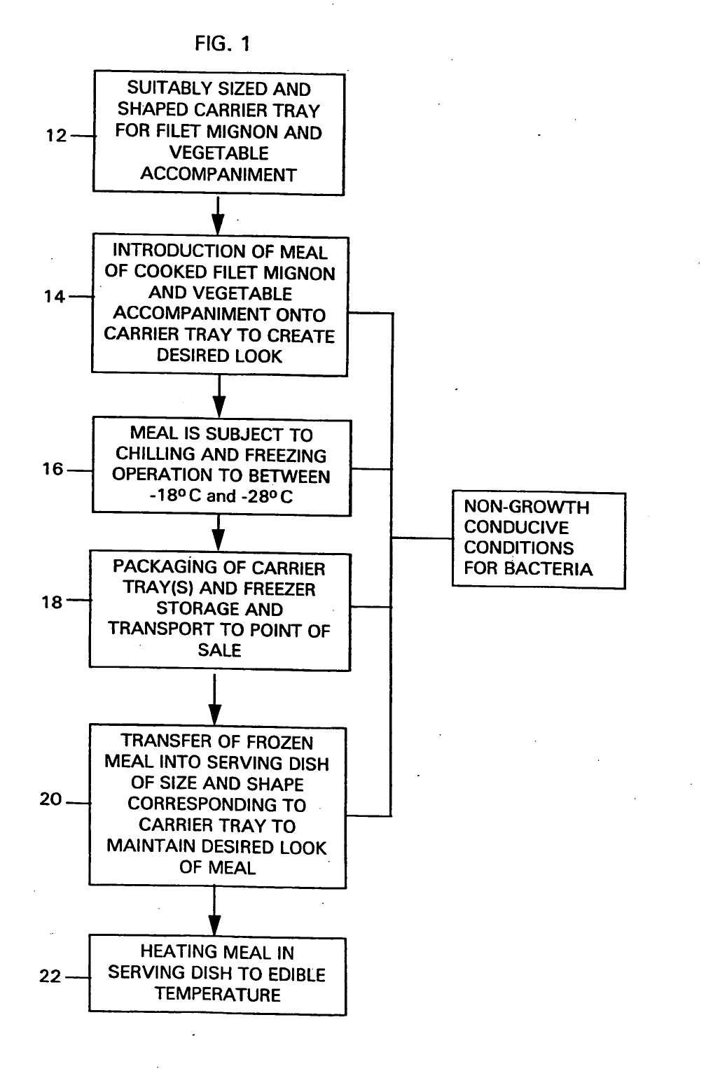

### DETAILED DESCRIPTION OF THE INVENTION

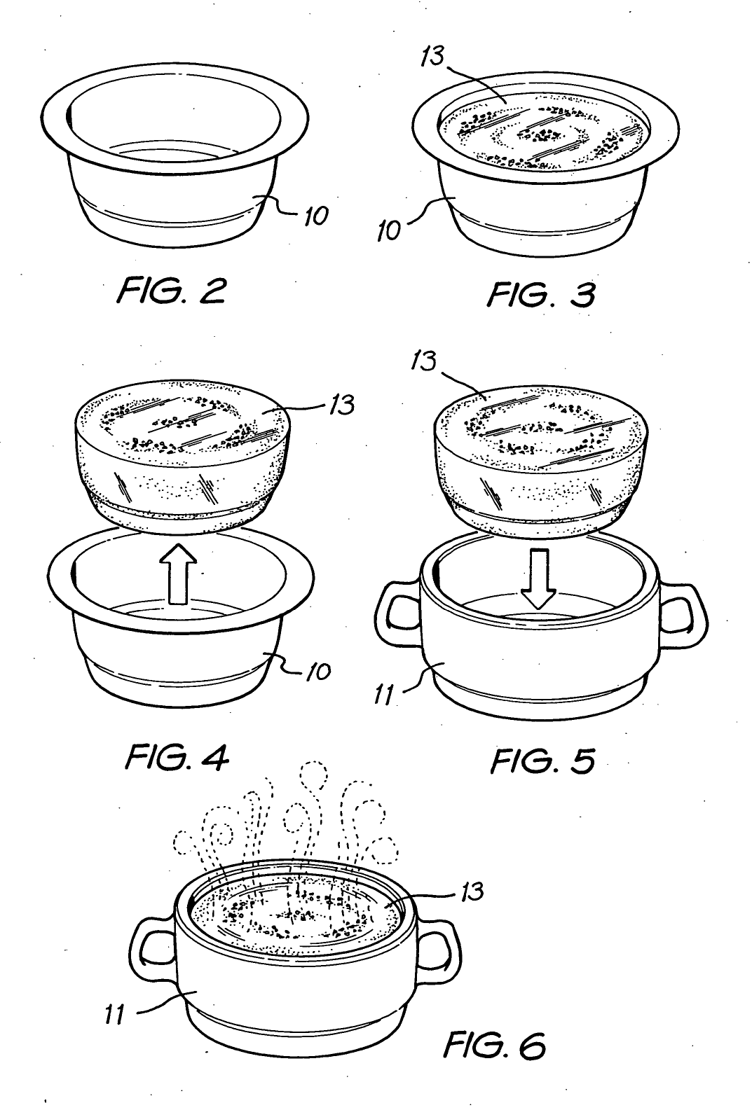

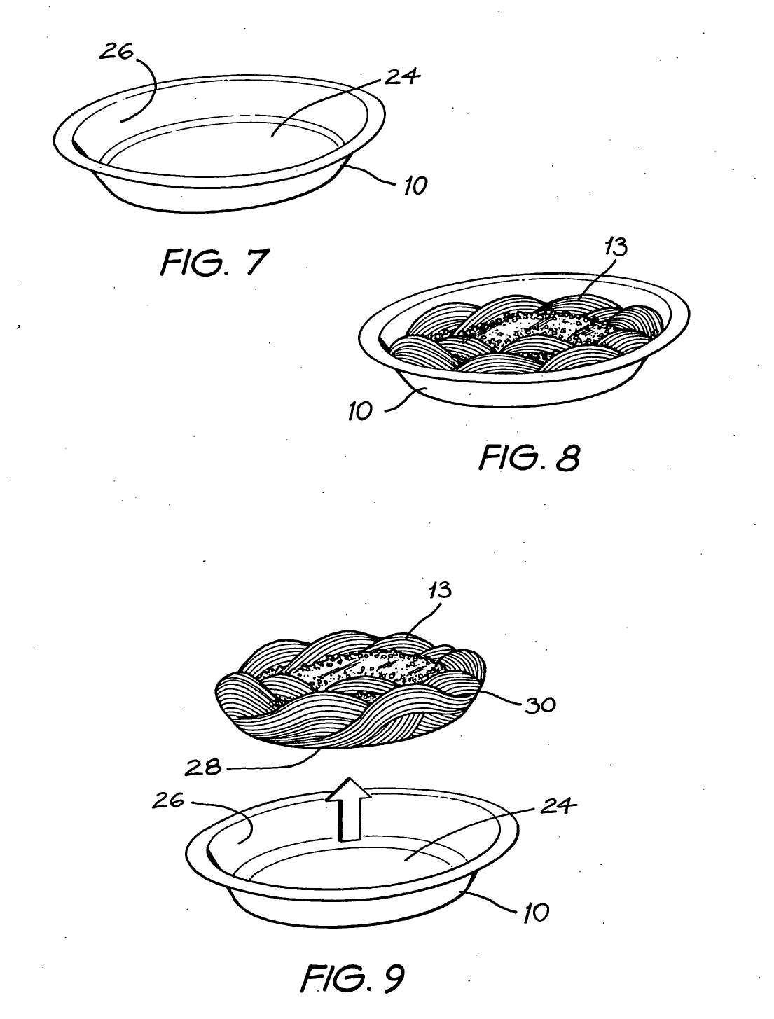

Referring in detail now to the drawings, where like or similar features are identified by like numerals, a carrier tray 10, fabricated of a flexible plastic, such as a polyethylene terephthalate (PET) which is recyclable, is provided in step 12. The carrier tray 10 includes a first base portion 24 and a first upright surface portion 26 (see especially FIGS. 7 and 9) having a size and a shape that match or correspond to that of a conventional or formal ceramic serving dish 11. The carrier tray 10 passes along a processing line in a meal assembly plant where various foods comprising the meal 13, in this case consisting of soup in FIGS. 2 to 6, and spaghetti bolognese in FIGS. 7 to 11, are introduced in step 14 into the tray at the desired positions to give the meal the desired look of a gourmet meal. The meal is thus received against the first base portion and the first upright surface portion so that a second base portion 28 and a second upright surface portion 30 (see especially FIG. 9) of the meal abut against and conform in size and shape to the first base portion and to the first upright surface portion. The meal, being a soup or a spaghetti bolognese, is heterogeneous in shape between a top part and a bottom part (i.e. from top to bottom), whereby the meal is presented in the carrier tray in an upright, ready to eat, orientation. Cooked food must be maintained at all times before and during this operation at above 60° C. to comply with health requirements.

When the introduction of food into the tray has been completed, the tray, with its assembled meal, is subject to the following chilling and freezing operation in step 16. The tray quickly passes through a nitrogen tunnel at −130° C. where the meal therein is snap chilled to no more than 5° C. to deactivate bacteria and other microorganisms, and the tray is then exposed to a batch blast freezer which freezes the meal to a range of between −18° C. and −28° C. to enable cold storage of the meal as a frozen meal. Alternatively, the nitrogen tunnel may, in addition to snap chilling the meal, be used to bring the temperature of the meal to the range of between −18° C. and −28° C. The duration of the chilling operation in the nitrogen tunnel need not be longer than about 7 minutes to fully deactivate the microorganisms. A spiral freezer may be used as an alternative to the nitrogen tunnel. This step preserves the size and the shape of the second base portion and the second upright surface portion of the meal.

After freezing, the carrier tray is packed in step 18 (along with other such carrier trays) into cartons or other storage assembly in a temperature controlled packaging room maintained at between about 8° C. and 14° C. and then palletized in the same room before being transferred into a storage freezer operating at between −18° C. and −28° C. When required, they are transported in step 18 by refrigerated transport to wholesalers or other points of sale. Subsequent storage of the suitably packed tray with its frozen meal in the wholesaler's freezer is necessary before it is ordered by a consumer and utilized in presenting a home meal replacement.

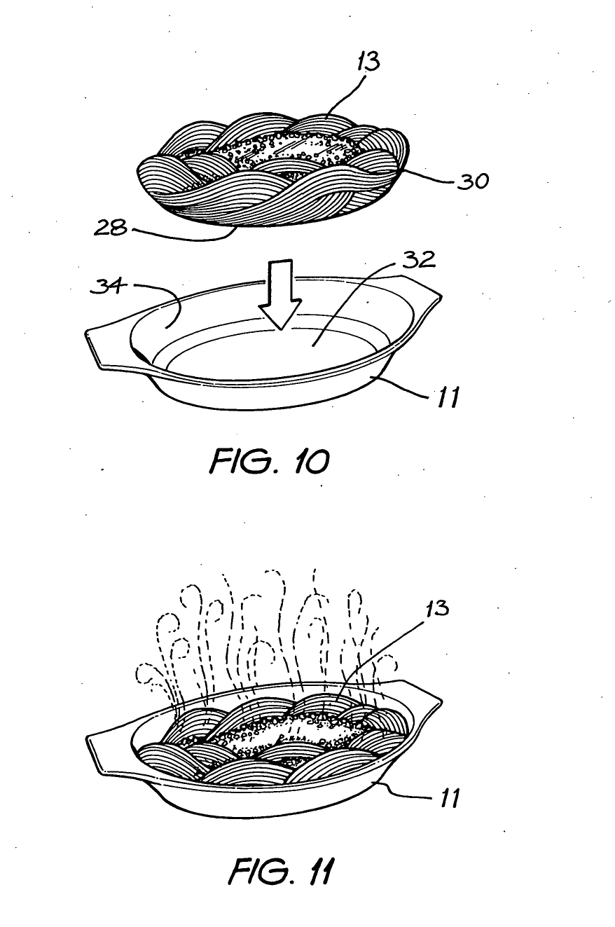

Prior to consumption, for some meals the tray is inclined or tilted by the person presenting the meal over the serving dish 11, which serving dish may be fabricated of a ceramic material commonly used in crockery. The serving dish has a third base portion 32 and a third upright surface portion 34 (see especially FIG. 10) of a size and a shape that corresponds substantially to the size and shape of the first base portion and the first upright surface portion of the carrier tray. The tray is so pressed by the person that the frozen meal is eased out of the tray, either with or without the aid of the second hand, and transferred in step 20 into the serving dish. For other meals, the tray is held vertically whilst the frozen meal is eased out of the tray by gentle finger pressure and bending of the flexible plastic walls of the tray. The flexible plastic used in the fabrication of the carrier tray allows a person to press or squeeze gently or otherwise tease the frozen meal out of the tray with no substantial disruption to the meal, thus preserving the desired look of the meal in the serving dish. In transferring the frozen meal into the serving dish, the second base portion and the second upright surface portion of the meal abut against and conform in size and shape to the third base portion and the third upright surface portion, respectively, of the serving dish in the upright, ready to eat, orientation, such that the look of a gourmet meal as prepared on the carrier tray is maintained.

The frozen meal in the ceramic serving dish may then be heated, or allowed to thaw sufficiently before being heated, in a microwave oven where it is heated in step 22 to edible or serving temperature before presentation to the consumer for consumption. In the case where the meal is a dessert course meal, such as a strawberry Romanoff, or a between course meal, such as a sorbet, intended to be consumed chilled, the frozen meal in the serving dish is allowed to thaw to a chilled serving temperature in controlled conditions before presentation to the consumer for consumption.

The kind of serving dish useful in the present invention will depend on the type of meal to be provided, which may be or include anything in the nature of a entree course meal, such as a lasagne requiring an elongated and shallow serving dish or a soup requiring a circular and deep serving bowl; a main course meal, such as a spaghetti bolognese in a ceramic serving plate of, say, large size and circular shape; and a dessert course meal, such as a strawberry Romanoff requiring a champagne style serving glass. Therefore, the scope of the term “serving dish” in the present application, and hence the nature of the correspondingly sized and shaped carrier tray, is not to be taken to comprise only conventional ceramic serving plates. Rather, the scope of the term “serving dish” may also include serving bowls for soup and serving glasses for ice desserts and sorbets, and any other serving device used for presenting the meal to a consumer.

The serving dish or dishes, having a like size and shape to that of the carrier trays, are supplied to the person presenting the meal, who may be the only consumer of the meal or one of the consumers of more than one meal, such as when the person is hosting a dinner party and desires a home meal replacement to serve the guests to the party. In that instance, the serving dishes may be supplied prior to, or concurrently with, the arrival of the frozen meals in the carrier trays from the point of sale, depending on what arrangement is made between the person hosting the dinner party and the supplier of the serving dishes.

The carrier tray is manufactured according to a size and shape that corresponds to the serving dish into which the meal is to be transferred. A die for the carrier tray is first manufactured to suit the intended meal for the carrier tray. The serving dish for the intended meal should, when manufactured, be of corresponding size and shape to the carrier tray made by the die. The carrier tray, and thus its die, may be ribbed, contoured, or have other structural features that provide the carrier tray with an aesthetically pleasing appearance or contribute to improved function, say, by reinforcing its strength and rigidity or by making it easier or safer to hold or otherwise manipulate for transferring the frozen meal into the serving dish. The carrier tray can be manufactured in large quantities from its die and utilized in a processing line where the meal is systematically introduced, chilled and frozen as described above.

The carrier tray may be returned to the manufacturer after its contents have been released therefrom for recycling of the plastic used in its fabrication or for sterilization which enables it to be reused.

The flexible and other structural properties of the plastic must withstand the temperature conditions it will experience during the freezing operation so as to ensure viability of the tray structure and its ability to be manipulated for releasing the meal from the tray into the serving dish.

The carrier tray may additionally be stackable with like carrier trays.

It is an advantage of the present invention that the position of, say, the various foods of the meal relative to the carrier tray is the same as the position of the various foods relative to the respective serving dish into which the meal has been transferred, so that a consumer may be presented with a meal for consumption as faithfully and reliably as was intended by the chef who originally presented the meal in the carrier tray.

It is apparent that the present invention will enable a person who is not skilled in cooking to present a complete gourmet style meal to the consumer in the shape, size and presentation as intended by the chef by the simple and easy steps of transferring the frozen meal from the carrier tray to the serving dish and then heating the meal to edible temperature.

At the present time, precooked frozen meals are assembled by manufacturers in disposable trays of foil, ovenable paper or plastic and sold as TV dinner style meals to the consumer. The consumer heats the meal as per instructions and may eat it out of the TV dinner style carrier tray or, in some cases, may combine a number of precooked frozen meals to assemble on a dish a meal that includes a variety of meat, vegetables or pasta and other accompaniments. The only original features of such meals that reach the consumer using these prior art methods are quantity and taste. Shape, size and presentation cannot be controlled when placing such a prepared meal on a dish. The dish, being of a different size, shape or style to the TV dinner style carrier tray, will not prevent the heated food distorting or otherwise looking differently from its original shape, size and presentation when placed on the serving dish, whereas the serving dish used in the process of the present invention has a like size and shape to the carrier tray.

This invention ensures that the consumer will receive a meal of the highest restaurant quality presentation and the person presenting the meal will have the confidence of a cordon bleu chef when serving it to any number of people. All variables that allow for the distortion of a preprepared meal are eliminated, and the final presentation is as the chef intended the meal to be served.

Various modifications may be made in details of design and construction without departing from the scope and ambit of the invention.

1. A process for providing a meal of a home meal replacement, comprising:
(i) providing a carrier tray for the meal of the home meal replacement to be served, the carrier tray including a first base portion and a first upright surface portion having a size and a shape for receiving the meal thereagainst,
(ii) introducing the meal into the carrier tray so that a second base portion and a second upright surface portion of the meal abut against and conform in size and shape to the first base portion and the first upright surface portion, the meal being heterogeneous in shape between at least a top part and a bottom part thereof, whereby the meal is presented in the carrier tray in an upright, ready to eat, orientation, and subjecting the meal to conditions that inhibit microorganism growth and contamination of the meal, the meal consisting of one or more foods that are introduced into the carrier tray at desired positions to simulate the look of a gourmet meal,
(iii) freezing the meal in the carrier tray to a temperature that enables the meal to be cold stored as a frozen meal until the meal is ready to be served, the size and the shape of the second base portion and the second upright surface portion of the meal thereby being preserved,
(iv) providing a serving dish for the carrier tray wherein the serving dish includes a third base portion and a third upright surface portion of a size and a shape that corresponds substantially to that of the first base portion and the first upright surface portion of the carrier tray,
(v) removing the frozen meal from the carrier tray and transferring it into the serving dish so that the second base portion and the second upright surface portion of the meal abut against and conform in size and shape to the third base portion and the third upright surface portion of the serving dish, the meal being presented in the serving dish in the upright, ready to eat, orientation, such that the look of a gourmet meal as prepared on the carrier tray is maintained, and
(iv) heating or thawing the meal in the serving dish to edible temperature for serving and consumption.

2. The process according to claim 1 wherein the carrier tray is fabricated of a flexible plastic.

3. The process according to claim 1 wherein the meal introduced into the carrier tray is selected from the group consisting of an entrée, a main course and a dessert.

4. The process according to claim 1 wherein the frozen meal is removed from the carrier tray by squeezing pressure applied on the carrier tray.

5. The process according to claim 1 wherein the serving dish is fabricated of a ceramic material.

6. The process according to claim 1 wherein the serving dish is a champagne style serving glass.
